(19) United States
(12) Patent Application Publication
(10) Pub. No.: US 2012/0229651 A1
(43) Pub. Date: Sep. 13, 2012

(54) IMAGE PICKUP APPARATUS WITH TRACKING FUNCTION AND TRACKING IMAGE PICKUP METHOD

(75) Inventor: Hiroshi Takizawa, Utsunomiya-shi (JP)

(73) Assignee: CANON KABUSHIKI KAISHA, Tokyo (JP)

(21) Appl. No.: 13/413,934

(22) Filed: Mar. 7, 2012

(30) Foreign Application Priority Data
Mar. 8, 2011 (JP) 2011-049798

(51) Int. Cl. H04N 5/225

(52) U.S. Cl. 348/169; 348/E05.024

(57) ABSTRACT

An image pickup apparatus with tracking function including a lens apparatus having aperture and focus adjust function and a camera apparatus connected to the lens apparatus and having an image pickup element. The apparatus has a movement detector that detects movement of an object to be tracked in a picked-up image, and a stop controller that performs a control of changing the aperture value of the aperture stop in an opening direction when movement of the object to be tracked is detected by the movement detector.

### BACKGROUND OF THE INVENTION

1. Field of the Invention

The present invention relates to an image pickup apparatus with tracking function for picking up an image while tracking a moving object and to a tracking image pickup method.

2. Description of the Related Art

What is called a tracking image pickup function is the function of picking up an image of a specific object while tracking it. The tracking image pickup function is used in digital cameras for optimization of parameters in shooting a figure or in surveillance cameras for automatic tracking image pickup of a suspicious figure. In a known method of detecting the object to be tracked, a template is created by extracting a characteristic feature(s) of an object, and the position of the specific subject in an image is detected by comparing the picked-up image and the template. However, if a similar figure or a background is present in the image, a false detection might occur in some cases, or enhancing the detection accuracy requires so long time in the comparison process that a fast moving subject cannot be tracked in some cases. In creating a template by extracting a characteristic feature(s) of an object and in comparing the image and the template, it is desirable that the picked-up image be sharp. Therefore, accurate focusing on the tracked object needs to be achieved.

Japanese Patent Application Laid-Open No. 562-251708 discloses an auto-focusing technique in which characteristic features of a plurality of objects are calculated while making the depth of field large by stopping down the aperture stop, and then the depth of field is made small by opening the aperture stop to allow focusing only on a desired object.

The prior art disclosed in Japanese Patent Application Laid-Open No. S62-251708 is intended to enable focusing only on a desired object by adjusting the depth of field. In cases where a specific object is to be detected and shot, this technique will be effective in eliminating false detection of the object when a person other than the target object (or subject) is present in front of or in rear of the object. However, in the case of shooting of a stationary object, the depth of field is generally determined according to the photographer's intention in image rendering (e.g. the intended degree of background blur), and it is rare that the depth of field is set in favor of accuracy in auto-focusing.

### SUMMARY OF THE INVENTION

An object of the present invention is to provide an image pickup apparatus with tracking function that can detect the direction and speed of movement of an object and control the aperture value of the iris appropriately in relation to the movement of the subject to thereby generate a natural image while tracking the object without false detection.

To achieve the above object, the image pickup apparatus with tracking function according to the present invention includes a lens apparatus having aperture and focus adjust function and a camera apparatus connected to the lens apparatus and having an image pickup element, a movement detector that detects movement of an object to be tracked in a picked-up image, and a stop controller that performs a control of changing the aperture value of the iris in an opening direction when movement of the object to be tracked is detected by the movement detector.

According to the present invention, appropriate aperture stop control is performed only when the object or background is moving, in accordance with the speed of the movement. In consequence, the accuracy of detection of the object can be improved without giving unnatural feeling to the operator of the apparatus or viewers of the image. Thus, the present invention can provide an image pickup apparatus with tracking function that is not likely to suffer from false tracking.

Further features of the present invention will become apparent from the following description of exemplary embodiments with reference to the attached drawings.

### BRIEF DESCRIPTION OF THE DRAWINGS

FIG. 1 is a diagram showing a camera platform system according to a first embodiment.

FIG. 2 shows an exemplary monitor display image output from a camera apparatus in the first embodiment.

FIG. 3 shows an exemplary monitor display image in a state in which the face detection function is enabled, in the first embodiment.

FIG. 4 is a flow chart illustrating an operation process in the first embodiment.

FIG. 5 shows an exemplary monitor display image in which the object to be tracked and the set display position coincide with each other, in the first embodiment.

FIG. 6 shows an exemplary monitor display image in which the object to be tracked has been moved.

### DESCRIPTION OF THE EMBODIMENTS

Preferred embodiments of the present invention will now be described in detail in accordance with the accompanying drawings.

### First Embodiment

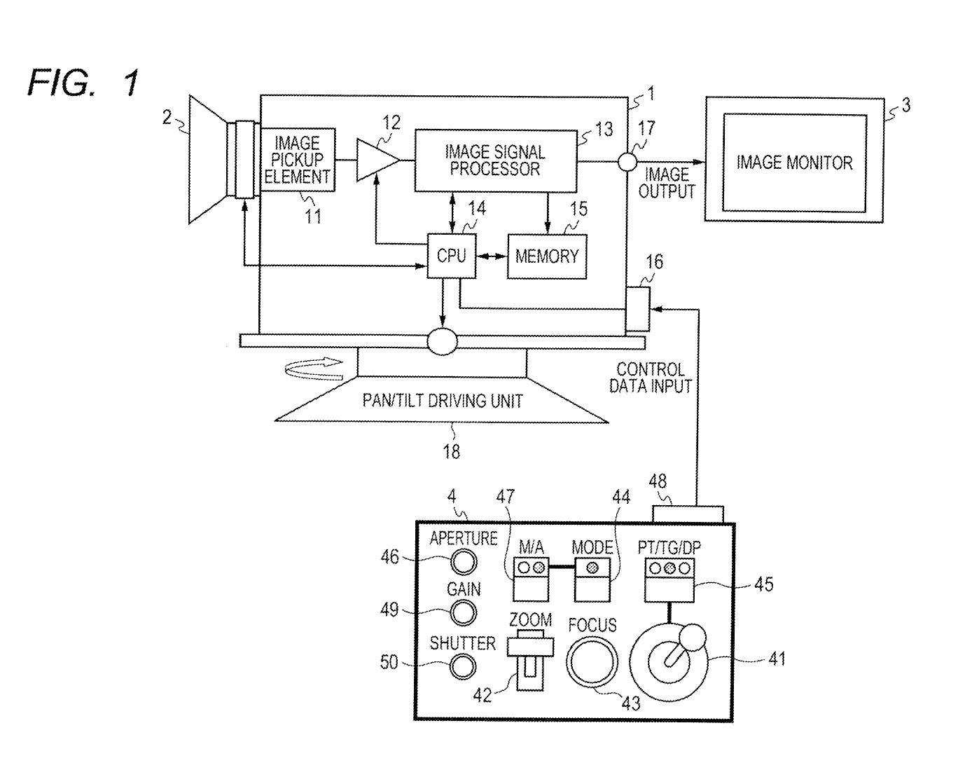

FIG. 1 is a system diagram of a remote-operated camera apparatus as an exemplary embodiment of the image pickup apparatus with tracking function according to the present invention. The basic system configuration will be firstly described with reference to FIG. 1.

As shown in FIG. 1, the image pickup apparatus with tracking function according to the present invention includes a remote-operated camera apparatus 1 mounted on a camera platform having a pan-tilt function, a lens apparatus 2 having an aperture adjust function and focus adjust function attached to the camera apparatus 1, an image monitor (display apparatus) 3 for displaying images picked by the camera apparatus 1, and an operation unit 4 for operating the camera apparatus 1 and the lens apparatus 2. An object image picked up through the lens apparatus 2 is formed on the image pickup element 11 of the camera apparatus 1 and picked up by it. The picked-up image signal undergoes level adjustment by the amplifier 12 serving as the gain changer, which changes the image pickup gain. Then, the image signal is processed on a pixel-by-pixel basis in the image signal processor 13 and once stored as image data in the memory 15. The image data is read, as need arises, for object detection or motion detection by a central processing unit (CPU) 14, which will be described later. The central processing unit (CPU) 14 is adapted to control the memory and the image signal processor 13. The image data read from the memory 15 is converted in the image signal processor 13 into data having a format suitable for display on the image monitor 3, and the data is output to the image monitor 3 through the image output terminal 17. The CPU 14 is also adapted to control a pan/tilt (P/T) driving circuit and a zoom/focus/aperture (Z/F/A) driving circuit in the lens apparatus 2. The CPU is further adapted to receive P/T/Z/F/I control data sent from the remote operation unit 4 for the camera apparatus 1 through a communication terminal 16, to send a pan/tilt (P/T) control signal to the pan/tilt driving unit 18 so as to drive the pan/tilt (P/T) motor, and to send a zoom/focus/aperture (Z/F/A) control signal to the lens apparatus 2.

The remote operation unit 4 is a unit for remotely operating the camera apparatus 1 and the lens apparatus 2. The remote operation unit 4 has a P/T operation part 41 for panning and tilting operation, a selection switch 45 for setting the function of the P/T operation part 41, a zoom operation part 42 for zooming operation, a focus operation part 43 for focus operation, an aperture adjusting knob 46 for aperture adjustment, a gain adjusting knob 49 for image pickup gain adjustment, a shutter adjusting knob 50 for adjusting a shutter that limits the quantity of light beams incident on the image pickup element 11 of the camera apparatus 1, a false-detection prevention switch 44 for enabling/disabling the false-detection prevention function, and a tracking mode selection switch 47 for selectively setting the automatic tracking mode/manual tracking mode as the tracking mode. The functions of the remote operation unit 4 will be described later together with the specific operations thereof.

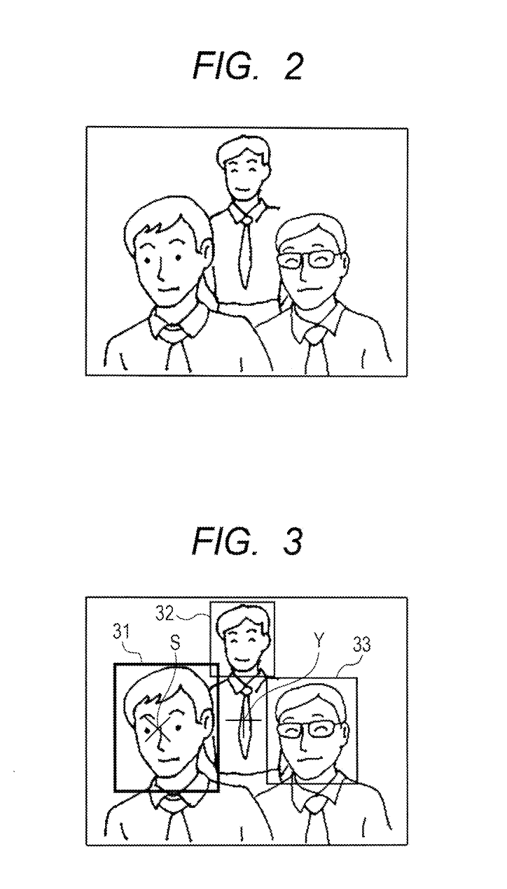

FIG. 2 shows an example of an object image output from the camera apparatus 1 and displayed on the image monitor 3. In the following, the operation of shooting while tracking the rightmost figure (i.e. the person with eye glasses) in FIG. 2 will be described. The CPU 14 of the camera apparatus 1 has a template for face detection in advance. The CPU 14 of the camera apparatus 1 extracts characteristic parts of faces such as eyes, noses and mouths in the entire area of the image and compares them with an enlarged or reduced template to detect areas that are presumed to be human faces. In the case shown in FIG. 2, the faces of three persons are detected, and a target object to be tracked is set as an initial setting.

In FIG. 3, the detected areas that are presumed to be human faces are indicated by frames 31, 32, 33, where the leftmost figure is set as the target to be tracked and highlighted by a thick frame 31. These frames are created by superimposing the frames on the picked-up image data by the image signal processor 13 based on display coordinates in the image area supplied from the CPU 14. The multiple display of the frames in the picked-up image may be provided by replacing the portions of the image data corresponding to the frame portions by frame line data. Alternatively, frame line data may be sent to the display monitor 3 as auxiliary data annexed to the image data with the image data kept intact, and the image data and the frame line data may be displayed on the display monitor 3 in a multiple manner.

Next, the operation of the remote operation unit 4 will be described. The function (PT) of the P/T operation part 41, which usually generates a control signal for the pan/tilt driving unit 18, is switched to the target selection function (TG) by the selection switch 45. As the P/T operation part 41 (selector) is moved or inclined upward/downward/left/right in this switched state, the remote operation unit 4 sends switching command data for switching the frame to an object frame located above/below/left/right in accordance with the direction of inclination of the operation stick of the P/T operation part 41 together with a signal indicating that the data is intended for selecting the target object to be tracked, to the camera apparatus 1 through the communication terminals 48, 16. The CPU 14 in the camera apparatus 1 recognizes this switching command data as a selection signal for selecting the tracked target from among a plurality of detected figures and selects, as the object frame to which the tracked target is switched, the frame located in the commanded direction (i.e. the direction of inclination of the operation stick of the P/T operation part 41) in relation to the object frame highlighted by the thick frame (frame 31 in FIG. 3) indicating the tracked target at that time to change the object frame drawn by the thick frame. Then, the coordinates S of the center of the new object frame drawn by the thick frame is memorized as the center position of the object to be tracked.

Then, a position in the picked-up image (or a coordinate position in the image pickup area) at which the object to be tracked is to be displayed is set. In this illustrative case, the target position at which the tracked object is to be displayed is set to the position of a cross line as shown in FIG. 3. The function of the P/T operation part 41 is switched to the display position setting function (DP) by the selection switch 45, and then the P/T operation part 41 is manipulated to send shift command data to the camera apparatus 1 thereby shifting the position of the cross line in the picked-up image. The CPU 14 of the camera apparatus 1 controls the image signal processor 13, as with the frame shift, in such a way as to shift the cross line in the image and memorizes the cross line stop coordinates Y (i.e. the coordinates at which the cross line is set) as the target display position.

After the completion of the above-described initial setting, the photographer performs focus adjustment and sets the stop, image pickup gain and shutter for the object to be tracked using the operation unit 4 so that an image he/she wishes can be obtained. The values of the stop, image pickup gain and shutter thus initially set are sent to the camera apparatus 1 as control values and memorized by the CPU 14.

Then, the false-detection prevention switch 44 may be operated to enable the false-detection prevention mode, and the tracking mode selection switch 47 may be operated. With these operations, a tracking start command is sent from the remote operation unit 4 to the camera apparatus 1, so that the mode is switched from the manual mode (M) to the automatic tracking mode (A). The aforementioned focus adjustment includes setting the focusing area of the auto-focusing (AF) in such a way that the object at the center coordinates S of the object frame comes in focus, so that the auto-focusing with the focusing area following the center coordinates S of the object to be tracked will be performed in the automatic tracking mode, though the AF operation will not be described in further detail.

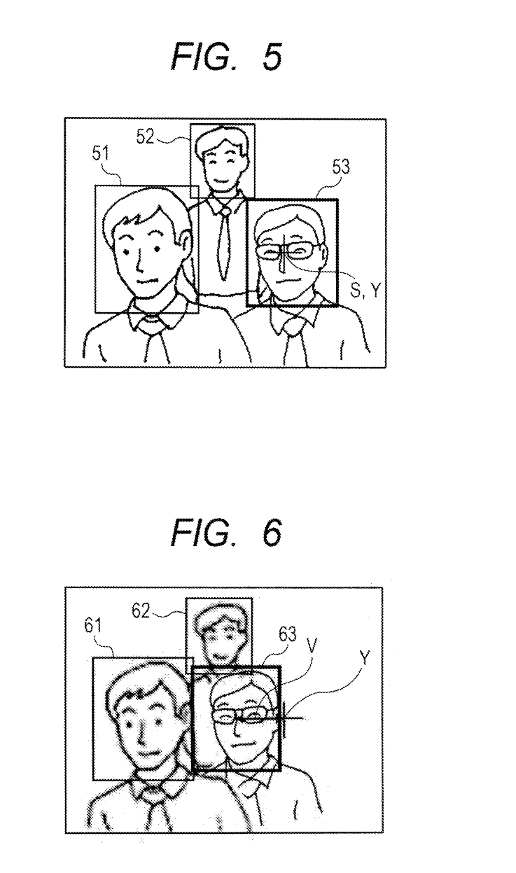

Upon receiving the tracking start command, the CPU 14 of the camera apparatus 1 outputs a P/T control signal to the pan/tilt driving unit 18 so that the coordinates S of the center of the object defined in the image pickup area (in the image) and the coordinates Y of the target display position coincide with each other. FIG. 5 illustrates a state in which the rightmost figure (highlighted with a thick frame) is set as the object to be tracked and the coordinates S of the center of the object highlighted by the thick frame and the coordinates Y of the target display position coincide with each other.

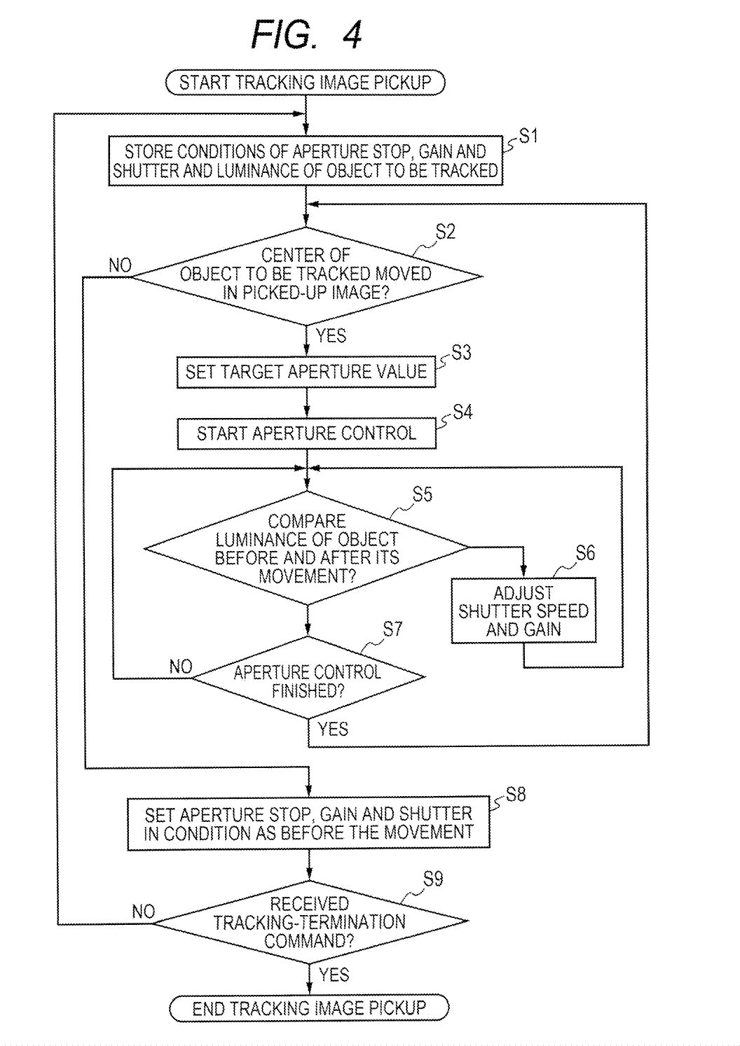

Now, the operation of the camera apparatus 1 according to the present invention since the start of tracking image pickup upon receiving the tracking start command from the operation unit 4 until the termination of the tracking image pickup upon receiving the tracking termination command from the operation unit 4 will be described with reference to FIG. 4. FIG. 6 shows a state in which the tracked object has been moved toward the center of the image from its position shown in FIG. 5. In the state shown in FIG. 6, P/T feedback for tracking is not applied. The CPU 14 (motion vector detector), which also serves as the movement detector and the velocity detector for the object to be tracked, performs face detection in the current frame and calculates the differences in the object center coordinates S and in the ratio of the face detection frame size between the current frame and the previous frame, thereby calculating the motion vector V of the object to be tracked based on coordinates in the picked-up image. The CPU 14 sets a stop control factor k (0<k<1) in accordance with the direction of the obtained motion vector V.

In step S1 in the flow chart of FIG. 4, the conditions of the aperture stop, gain and shutter and the luminance of the object to be tracked are memorized, and the process proceeds to step S2. In step S2, it is determined whether the position of the center of the object to be tracked has moved (or shifted) in the image pickup area (i.e. whether the coordinates S in the image pickup area have changed) or not. If it is determined that the position of the center of the object to be tracked in the image pickup area has changed, the process proceeds to step S3, and if it is determined that the position of the center has not changed, the process proceeds to step S8.

In step S3, a target value to which the aperture value is to be changed is set by the CPU 14, which also serves as the stop controller, and the process proceeds to step S4. In setting the target value to which the aperture value is to be changed, a control factor k (0<k<1) for the aperture value F used in the image pickup before the movement of the object may be set, and the target value to which the aperture value is to be changed may be set to be F×k.

In step S4, a control for changing the aperture value to the target value is started, and the process proceeds to step S5. In step S5, the CPU 14 determines whether the difference between the luminance of the object detected by the image signal processor 13 (luminance detector) and that before the movement of the object falls within a predetermined range or not. If the difference falls within the predetermined range, the process proceeds to step S7, and if the difference exceeds the predetermined range, the process proceeds to step S6. In step S6, the CPU 14, which serves as the luminance controller, adjusts the shutter and/or the image pickup gain in such a way as to make the luminance of the object substantially equal to that before the movement of the object. Then, the process returns to step S5. The predetermined range used as the criterion of the determination as to the luminance in step S5 may be set to ±10%, more preferably ±% 5, still more preferably ±3% of the luminance of the object before movement.

In step S7, it is determined whether the aperture control started in step S4 to change the aperture value to the target aperture value has been completed or not. If the aperture control has been completed, the process returns to step S2, and if the aperture control has not been completed yet, the process returns to step S5.

In step S8, the aperture stop, shutter and image pickup gain are set to their conditions before the movement of the object, and the process proceeds to step S9. In step S9, it is determined whether the tracking termination command has been received or not. If the tracking termination command has not been received, the process returns to step S1. If the tracking termination command has been received, the tracking image pickup is terminated.

In the case, for example, where the tracked object frame moves sideway in the picked-up image as shown in FIG. 6, a control factor (e.g. k=0.5) is set in step S3 in FIG. 4. For instance, if the aperture value F set by the photographer before the tracking image pickup is started is 4.8, the target aperture value F is set to 2.4. Thus, in the case where the object moves in the horizontal direction, the target value for the stop is set in such a way as to open the aperture stop, and the aperture stop is driven in the opening direction, and in the aperture control steps (steps S4 to S7 in FIG. 4) the aperture stop is driven in the opening direction (in the direction toward the full aperture) to the target f-number so as to decrease the depth of field. Since the AF control area changes to contain the object, accuracy of focusing on a figure(s) located in front/rear of the object will decrease, leading to deterioration in the resolution of its (their) image (i.e. resulting in image blur). Deterioration in the resolution makes the probability of face detection in the frame 61 and frame 62 lower. Therefore, even if the object frame 63 moves in the image, the probability of false detection of the figure in the frame 61 or frame 62 as the object to be tracked can be reduced. False detection can be effectively prevented particularly in the case where motion prediction is adopted in detecting the object and an object resembling the object to be tracked is present at the predicted location, because the discrimination between the object to be tracked and other objects can be improved.

In the process flow shown in FIG. 4, the aperture control in step S3 and subsequent steps for preventing false detection of the object frame to be tracked is performed if the position of the center of the tracked object shifts in the image. However, the aperture control in step S3 and subsequent steps is not executed in the case where the movement of the tracked object has only a component in the direction toward or away from the lens apparatus, because the position of the center of the tracked object does not change in the image in this case. In this case, although the relative size of the object frame to be tracked in the image changes with the movement of the object in the direction toward or away from the lens apparatus, the object to be tracked, which remains at the same position in the image, is kept in focus by the AF. Consequently, the probability the false detection that another figure or the like is erroneously detected as the object to be tracked is low. Therefore, it is not necessary to execute the aperture control to reduce the sharpness of the images of objects other than the object to be tracked.

FIG. 6 shows a state in which pan/tilt feedback for tracking is not applied. As described before, when a motion vector of the object frame to be tracked in the image is detected, pan/tilt control is performed by the CPU (pan/tilt controller) so as to move the camera apparatus 1 in the direction of the motion vector. Thus, the object to be tracked is displayed in the neighborhood of the initially set position Y, even when the object to be tracked moves. In other words, while pan/tilt control is performed to drive the camera apparatus 1 in accordance with the movement of the tracked target object, the background and figures other than the tracked target displayed in the image are moving. Therefore, even if the resolution of the images of the objects other than the tracked target object is deteriorated to some extent by a decrease in the depth of field, the change in the resolution will hardly be noticed by the viewers of the picked-up image.

Moreover, performing the aperture control will lead to a change in the incident light quantity. In the initial setting, the average luminance in the vicinity of the center S of the object to be tracked is memorized by the CPU 14, and the shutter (not shown) and the image pickup gain in the amplifier 12 are adjusted in such a way as to make the luminance substantially equal to the memorized average luminance, thereby making the change in the luminance of the object small (in step S6 in FIG. 4). When the object frame to be tracked moves to cause a change in the coordinates of its center in the image pickup area, the aperture stop is opened, leading to an increase in the luminance. Therefore, the shutter speed is adjusted to be made higher, and the image pickup gain is adjusted to be made lower. In the case of video cameras, the function of the shutter is implemented by adjusting the time over which signals are taken from the image pickup element.

As the object to be tracked stops moving in the image pickup area, or as the magnitude of the detected motion vector becomes substantially small, the aperture value, image pickup gain and shutter are set to the initial values or the values set before the shift to the tracking mode. Since deterioration in the resolution is easily noticeable while an object stands still, the settings are returned to the previous settings to reduce the image blur of the objects other than the object to be tracked, thereby reducing the strangeness of the image.

As described above, by performing the aperture control in accordance with the movement of the object and adjusting the image pickup gain and shutter appropriately, the accuracy in the detection of the object to be tracked during the tracking image pickup can be improved without deviating from the intent of the photographer. Although the above description has been made in a rather simple manner with reference to specific illustrative values of the control factor and f-number in order to describe the basic idea, the present invention is not limited to these values or the mode of implementation.

In the above description, the difference in the position between frames is referred to as the amount of movement of the object to be tracked. In cases where the pan/tilt feedback control of the camera apparatus for tracking is performed and pan/tilt driving is performed in such a way as to display the object to be tracked at a predetermined position, the amount of movement caused by panning/tilting is also taken into account in calculating the amount of movement. The basic concept of the invention can also apply to such cases without a substantial change.

In the above-described control process, the control is performed to decrease the depth of field when the object moves upward/downward/right/left in the image. If the pan/tilt tracking control is performed when the speed of the movement of the object is high, the background image moves at high speed in the image area. Then, deterioration in the resolution will become less noticeable, and the strangeness that the viewers of the picked up image will feel as the depth of field is decreased will be reduced. Therefore, when the coordinates of the center of the object frame to be tracked change in the picked-up image, the higher the speed of the movement of the object is, the smaller the depth of field may be intended to be set. Thus, the probability of false detection of the object to be tracked can further be reduced by using the speed of movement of the object to be tracked as an additional parameter in determining the aperture control factor.

### Second Embodiment

As described above, the smaller the depth of field is made by changing the aperture value initially set by the photographer without affecting the appearance of the image, the higher the effect of the invention is. Nevertheless, the stop might be set to be nearly fully open (close to full aperture) in some cases to meet shooting conditions. There may also be cases where a large depth of field is initially set to allow large decrease in the depth of field in order to enjoy the effect of the present invention. However, when shooting is performed in a state in which the stop is nearly fully open, it is difficult to further open the stop to decrease the depth of field so as to enjoy the effect of the present invention described in connection with the first embodiment. On the other hand, if a large depth of field is initially set in order to enjoy the effect of the present invention, an image that the photographer wishes to obtain cannot be obtained in some cases.

In view of the above, in this embodiment, when the mode for preventing false detection of the object to be tracked is enabled, if the current setting does not allow to enjoy the effect of the invention greatly, a notification to that effect is displayed on the operation unit. Specifically, a notification to the effect that it is difficult to effectively reduce the probability of false detection of the object to be tracked, when the position of the center of the object to be tracked changes in the image pickup area, by changing the stop in the opening direction to decrease the depth of field thereby decreasing the sharpness of the images of the objects other than the object to be tracked.

If the CPU 14 receives a control command for enabling the false-detection prevention mode in a state in which the aperture cannot be changed in the opening direction or in a state in which the aperture value F cannot be changed to ½ of less of that before the movement of the object to be tracked, the CPU 14 returns a response signal to the operation unit to indicate that there is not a sufficient margin for the aperture control (or for change of the aperture in the opening direction) (more specifically, to indicate that the target value to which the aperture value is to be changed falls out of the range of variation of the aperture value). Furthermore, in cases where the initial setting does not allow to keep the luminance of the tracked object substantially equal to that before the movement of the object by the adjustment of the gain and/or shutter, the CPU 14 makes a determination and returns a response signal to the operation unit 4 to indicate that the aperture value is not appropriate. The operation unit 4 has means for notifying the operator of the above fact (e.g. blinking the indicator of the switch 44) when receiving this response signal. The operation unit 4 may be adapted to indicate a plurality of states by, for example, different blinking cycles or different light colors.

Since the operator can know in advance, from the blinking of the indicator, whether the effect of the invention can be enjoyed or not, he/she can readjust the initial stop setting to enjoy the effect with reliability. The operator (i.e. photographer) may stick to the setting that provides the depth of field he/her wishes to leave the aperture value unchanged, accepting the smallness of the false-detection prevention effect in detecting the object to be tracked. Thus, the photographer can enjoy shooting at will without being constrained by the function provided by the present invention.

### Third Embodiment

In the present invention, the false-detection prevention in detecting the object frame to be tracked is most effective when there are a plurality of objects that can be the target of tracking and the center of the object frame to be tracked moves in the image pickup area. When the movement of the object(s) other than the object to be tracked or the movement of the object to be tracked during the image pickup result in the disappearance of the objects other than the object to be tracked from the picked-up image, it is desirable to disable the automatic aperture control function according to the present invention in order to pick up more natural images. In view of this, the CPU 14 is adapted to count the number of detected objects, and when the object(s) other than the object to be tracked disappears from the picked-up image, the CPU 14 disables the automatic aperture control function and sends information to the effect that this function is being disabled to the operation unit 4. Upon receiving this information, the operation unit 4 turns off the indicator of the false-detection prevention switch 44. If the mode set by the tracking mode selection switch 47 is the automatic mode (A), the automatic aperture control function is automatically enabled again at the time when the number of objects that can be the target of tracking becomes two or more. Then, the indicator of the false-detection prevention switch 44 of the operation unit is turned on by a control of the CPU 14 to notify the operator. The function of automatically enabling/disabling the automatic aperture control function in accordance with the number of objects that can be the target of tracking can make tracking image pickup more natural.

Exemplary embodiments of the present invention have been described with reference to specific numerals and a specific method of detection of a human face as the target of tracking by comparison with a template, for the sake of ease of description. However, it is to be understood that the invention is not limited to the disclosed exemplary embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-049798, filed Mar. 8, 2011, which is hereby incorporated by reference herein in its entirety.

What is claimed is:

1. An image pickup apparatus with tracking function including a lens apparatus having aperture and focus adjust function and a camera apparatus connected to the lens apparatus and having an image pickup element, comprising:
a movement detector that detects movement of an object to be tracked in a picked-up image; and
a stop controller that performs a control of changing an aperture value of an aperture stop in an opening direction when movement of the object to be tracked is detected by the movement detector.

2. An image pickup apparatus with tracking function according to claim 1, further comprising a selector that selects the object to be tracked from among a plurality of objects in a picked-up image.

3. An image pickup apparatus with tracking function according to claim 1, wherein when movement of the object to be tracked is detected by the movement detector, the stop controller performs the control to make the aperture value equal to F×k, where F is the aperture value of the aperture stop before movement of the object to be tracked, and k is a certain value in the range of 0<k<1.

4. An image pickup apparatus with tracking function according to claim 1, further comprising:
a luminance detector that detects luminance of the object to be tracked in the picked-up image;
a shutter that regulates quantity of light beams incident on the image pickup element of the camera apparatus; and
a luminance controller that controls at least one of an image pickup gain and shutter in such a way that the difference between luminance of the object to be tracked and luminance before movement of the object to be tracked falls within a predetermined range, when the stop control for the aperture stop is performed.

5. An image pickup apparatus with tracking function according to claim 1, further comprising a velocity detector that detects the velocity of movement of the object to be tracked in the picked-up image, wherein the higher the velocity of the object to be tracked detected by the velocity detector is, the more the stop controller controls the aperture value of the aperture stop to change in the opening direction.

6. An image pickup apparatus with tracking function according to claim 3, further comprising an indicator that indicates that a target aperture value to which the aperture value is to be changed falls out of the range of variation of the aperture value, in the control of the aperture value performed by the stop controller.

7. An image pickup apparatus with tracking function according to claim 4, further comprising an indicator that indicates that the set values of the image pickup gain and shutter do not allow the luminance controller to control at least one of the image pickup gain and shutter in such a way that the difference between luminance of the object to be tracked and luminance before movement of the object to be tracked falls within the predetermined range.

8. An image pickup apparatus with tracking function according to claim 1, wherein the function of the stop controller is enabled when a plurality of objects that can be an object to be tracked are detected in the picked-up image.

9. An image pickup apparatus with tracking function according to claim 1, further comprising:
a camera platform with which the lens apparatus and the camera apparatus are panned and tilted;
a pan/tilt controller that control pan and tilt driving of the camera platform; and
a motion vector detector that detects a motion vector of the object to be tracked in the picked-up image,
wherein the pan/tilt controller controls a pan and tilt driving of the camera platform in such a way that the object to be tracked is displayed at a specific position in the image, based on the motion vector detected by the motion vector detector.

10. A tracking image pickup method for picking up an image while tracking an object in an image pickup apparatus including a lens apparatus having aperture and focus adjust function and a camera apparatus connected to the lens apparatus and having an image pickup element, the method comprising:
extracting an object that can be an object to be tracked in a picked-up image;
selecting an object to be tracked from among the extracted object;
memorizing set values of an aperture value of an aperture stop, image pickup gain and shutter, and luminance of the object to be tracked; and
detecting movement of the object to be tracked in the picked-up image,
wherein if movement of the object to be tracked is detected, a target aperture value that is closer to the full aperture than the memorized aperture value is set, then the aperture stop is driven to the target aperture value with at least one of the image pickup gain and shutter being adjusted in such a way that a difference between luminance of the object to be tracked and the memorized luminance falls within a predetermined range, and the set values of the aperture value, image pickup gain and shutter are made equal to the memorized set values again after the aperture stop has been driven to the target aperture value.
